SEQUENCE LISTING (3 sequences)

SEQ ID NO: 1 - protein, 26 aa, Lilium Stargazer
GRELAEETKENTEKRATEAGVADQKY

SEQ ID NO: 2 - protein, 51 aa, Lilium Stargazer
GGGYNNGGGYPGGGGGYHNGGGYPGGGGGYPGGGGGYPGGGGGYHNGGGGG

SEQ ID NO: 3 - protein, 38 aa, Lilium Stargazer
RCYNGCCRRGYYGGCRCCAHPDEIPDPEYRAEPAYGHP

(19) United States
(12) Patent Application Publication
(10) Pub. No.: US 2015/0045287 A1
(43) Pub. Date: Feb. 12, 2015

(54) ANTIMICROBIAL COMPOSITION FOR INHIBITING MICROBIAL ORGANISMS AND THE METHOD THEREOF

(71) Applicant: National Taiwan University, Taipei (TW)

(72) Inventors: Chao-Ying CHEN, Taipei (TW); Chia-Hua LIN, Taipei (TW); Min-Wei CHANG, Taipei (TW)

(73) Assignee: National Taiwan University, Taipei (TW)

(21) Appl. No.: 13/963,432

(22) Filed: Aug. 9, 2013

(51) Int. Cl. A01N 47/44; A01N 43/50

(52) U.S. Cl. CPC A01N 47/44; A01N 43/50
USPC 514/2.8; 514/2.3; 514/2.4; 514/3.3

(57) ABSTRACT

The invention relates to a method of controlling or combating microbial organism by applying an antimicrobial peptide to the microbial organisms, wherein said antimicrobial peptide derived from Lilium ‘Stargazer’ glycine-rich protein 1. In addition, the present invention provides an antimicrobial composition comprising an antimicrobial peptide of the invention, an additional biocidal agent and pharmaceutically acceptable vehicles, excipients, diluents, and adjuvants.

### BACKGROUND OF THE INVENTION

1. Field of the Invention

The present invention relates to a method of controlling or combating microbial organism,. The invention also relates to an antimicrobial composition for inhibiting microbial organism.

2. Description of the Prior Art

Antimicrobial peptides (AMPs) are natural antibiotics that act as a primary defense barrier to prevent the invasion of pathogenic microorganisms in living organisms. Recently, scientific studies have disclosed a class of naturally occurring antimicrobial peptides in humans, mammals, plants, insects and other organisms. Generally these peptides have a net positive charge (i.e., cationic), and it is believed that these peptides antimicrobial efficacy is attributed to their ability to penetrate and disrupt the microbial membranes, thereby killing the microbe or inhibiting its growth,

Plant AMPs are 3-10 kDa cationic peptides that exhibit a high content of cysteine and/or glycine residues. These plant AMPs are expressed constitutively or are induced following pathogen attack, and most are localized in extracellular matrix. The structures of plant .AMPs are generally stabilized by cysteine-linked intramolecular disulfide bridges, which ensure the effective interaction of AMPs with microbial plasma membranes and lead to disruption of membrane integrity of the microorganisms (Pelegrini et al. 2011; Hammam et al. 2009). In addition to membrane permeabilization, other antimicrobial mechanisms of AMPs have been proposed, such as the suppression of nucleic acid and protein synthesis, inhibition of enzymatic activity, and induction of programmed cell death (Brogden, 2005; De Brucker et al. 2011; Rahnamaeian, 2011). Because AMPs exhibit diverse modes of action and broad-spectrum antimicrobial activity, they are highly recommended candidates for drug development and plant disease control (Brandenburg et al. 2012; Montesinos, 2007; Stotz et al. 2009).

Induced resistance in plants refers to a state with enhanced defenses in response to biotic and abiotic stress (Bostock, 1999; Sticher et al, 1997; van Loon et al. 1998; Durrant and Dong, 2004). The plant hormone salicylic acid is a disease resistance modulator involved in defensive signaling and stimulates the expression of numerous defense genes in many plant systems (Alvarez, 2000; Kessmann et al. 1994). LsGRP1 (Lilum ‘Stargazer’ glycine-rich protein 1) is a defense-related gene of lily that is differentially expressed post-treatments with salicylic acid and probenazole and after inoculation with Bottytis elliptica (Berk.) Cooke. LsGRP1 is predicted to encode a glycine-rich protein of 138 amino acids (a.a.) containing a 23-a.a. N-terminal signal peptide, which targets the mature protein to the plasma membrane or extracellular matrix. The deduced LsGRP1 sequence shares greater than 53% similarity with various plant GRPs and has a highly conserved domain structure, including an N-terminal signal peptide, a central glycine-rich domain and a C-terminal cysteine-rich domain (Chen et al. 2003; Lu and Chen, 2005; Lu et al. 1998, 2007).

However, to date there have not been any reports to identify the antimicrobial activity of LsGRP1-derived peptides. There is a need in the art to explore the great potential of LsGRP1-derived peptides for antimicrobial application.

### REFERENCE CITED [REFERENCED BY]

### OTHER REFERENCE

Alvarez M E (2000) Salicylic acid in the machinery of hypersensitive cell death and disease resistance. Plant Mol. Biol. 4:429-442.

Bostock R M (1999) Signal conflicts and synergies in induced resistance to multiple attackers. Physiol. Mol. Plant Pathol. 55:99-109.

Brandenburg L-O, Merres J, Albrecht L-J, Varoga D, Pufe T (2012) Antimicrobial peptides: Multifunctional drugs for different applications. Polymers 4:539-560.

Brogden K A (2005) Antimicrobial peptides: Pore formers or metabolic inhibitors in bacteria? Nat. Rev. Microbiol. 3:238-250.

Chen C Y, Lu Y Y, Chung J C (2003) Induced host resistance against Botrytis leaf blight. In Huang, H., C. and Acharya, S., N. (Eds), Advances in plant disease management (pp. 259-267). Management. Research Signpost, Trivandrum, Kerala, India.

De Brucker K, Cammue B P A, Thevissen K (2011) Apoptosis-inducing antifungal peptides and proteins. Biochem. Soc. Trans. 39:1527-1532.

Durrant W E, Dong X (2004) Systemic acquired resistance. Annu. Rev. Phytopathol. 42:185-209.

Hammami R, Ben Harnida J, Vergoten G, Fliss I (2009) PhyEAMP: a database dedicated to antimicrobial plant peptides. Nucleic Acids Res. 37;963-968.

Kessmann H, Staub T, Hofinann C, Maetzke T, Herzog J, Ward E, Ukases S, Ryals J (1994) Induction of systemic acquired resistance in plants by chemicals. Annu. Rev. Phytopathol. 32: 439-459.

Lu Y Y, Chen C Y (1998) Probenazole-induced resistance of lily leaves against Botrytis elliptica. Plant Pathol. Bull. 7:134-140.

Lu Y Y, Chen C Y (2005) Molecular analysis of lily leaves in response to salicylic acid effective towards protection against Botrytis elliptica. Plant Sci. 169:1-9.

Lu Y Y, Liu Y H, Chen C Y (2007) Stomatal closure, callose deposition, and increase of LsGRP1-corresponding transcript in probenazole-induced resistance against Botrytis elliptica in lily. Plant Sci. 172:913-919.

Montesinos E (2007) Antimicrobial peptides and plant disease control. FEMS Microbiol. 270:1-11.

Pelegrini B P, Del Sarto R P, Silva O N, Franco O L, Grossi-de-Sa M F (2011) Antibacterial peptides from plants: what they are and how they probably work. Biochem. Res. Int. 2011:250349.

Rahnamaeian M (2011) Antimicrobial peptides: Modes of mechanism, modulation of defense responses. Plant Signal Behay. 6:1325-1332.

Sticher L, Mauch-Mani B, Metraux JP (1997) Systemic acquired resistance. Annu. Rev. Phytopathol. 35: 235-270.

Stotz H U, Thomson J G, Wang Y (2009) Plant defensins: Defense, development and application. Plant Signal Behay. 4:1010-1012.

van Loon L C, Bakker P A H M, Pieterse, C M J (1998) Systemic resistance induced by rhizosphere bacteria. Ann. Rev. Phytopathol. 36: 453-483.

### SUMMARY OF THE INVENTION

In the first aspect the invention relates to a method of controlling or combating microbial organisms, comprising applying an antimicrobial peptide to the microbial organism, such as fungal organisms or bacteria, wherein said antimicrobial peptide is selected from the group consisting of LsGRP1^{N} (SEQ ID NO:1), LsGRP1^{G} (SEQ ID NO:2), LsGRP1^{C} (SEQ ID NO:3), and peptide with at least 80% sequence similarity to sequences of LsGRP1^{N}, LsGRP1^{G}, and LsGRP1^{C}.

In the second aspect the present invention relates to an antimicrobial composition comprising, as an active ingredient, an antimicrobial peptide of the invention, which may further comprise an additional biocidal agent and phatmaceutically acceptable vehicles, excipients, diluents, and adjuvants .

The antimicrobial peptide of the present invention can be used to treat any target microbial organism. For example, the target microbial organism of the present invention can be any bacteria or fungi. In one embodiment, the target microbial organism is a gram-positive bacterium, such as Bacillus subtilis 28-4. In another embodiment, the target microbial organism is a gram-negative bacteria, such as Pseudomonas syringae pv. Syringae 61, Agrobacterium tumefaciens C58C¹, Escherichia coli DH5α, Dickey chrysanthemi TA1 and Xanthomonas campestris XCP3. In yet another embodiment, the target microbial organism is a fungus, such as Alternaria brassicicola Ac1, Botrytis cinerea B-134, Botrytis elliptica B061, Colletotrichum acutatum HL1, or Colletotrichum gleosporioides MT1.

In general, the antimicrobial peptide of the present invention can be used to treat a target microbial organism at any place, e.g., at a plant surface, and at any tissue including surfaces of any implant.

Furthermore, the antimicrobial peptide of the present invention can be used in a wound healing composition or hygiene products, such as bandages, anti-dandruff hair products, and wet wipe.

### BRIEF DESCRIPTION OF THE DRAWINGS

FIG. 1 shows schematic pattern and antimicrobail activity predition of LsGRP1-derived peptides. LsGRP1^{N}, LsGRP1^{G} and LsGRP1^{C} are indicated on different blocks of the deduced LsGRP1 sequence. The antimicrobial activity of LsGRP1-derived peptides predicted by server AMPA (Torrent et al. 2009), APD2 (Wang et al. 2009), AntiBP2 (Lata et al. 2007), CAMP (Thomas et al. 2010) and ClassAMP (Joseph et al. 2012) was shown below. A putative antimicrobial activity was predicted (+) or not predicted (−). “+/−” indicates an ambiguous result predicted by the server.

FIG. 2 shows analysis of antimicrobial activity of LsGRP1-derived pepides. (A) Bacterial growth inhibited by LsGRP1-derived peptides. The bacterial suspension with an OD₆₉₀ of 0.15 was treated with 2.5 mg/mi peptide solution for 90 min, and the CFUs in each peptide sample were measured at 20-24 h post treatment by serial-dilution plating. Inhibition rate (%)=[(CFUs in water treatment−CFUs in peptide treatment)/CFUs in water treatment]×100%. (B) Spore germination of plant fungal pathogens inhibited by LsGRP1-derived peptides. Fungal spores with a concentration of 1×10⁵sporeslmi were treated with 2.5 mg/ml peptide for 16-20 h before the observation of spore germination under light microscope. Inhibition rate (%)=[(Number of spores germinating in water−Number of spores germinating in peptide solution)/Number of spores germinating in water]×100%.

FIG. 3 shows changes in morphology and membrane permeability of bacteria treated with LsGRP1^{C}. (A) Observation of P. syringae pv. syringae 61 and X. campestris XCP3 by scanning electron microscopy post LsGRP1^{C} treatment. Bar=4 μm (for P. syringae pv. syringae) or 5 μm (for X. campestris). (B) SYTOX Green-stained P. syringae pv. syringae 61 and X. campestris XCP3 post LsGRP1^{C} treatment. Bar=10 μm.

FIG. 4 shows effect of LsGRP1^{C} on plant fungal pathogens. The fungal spores (A) and hyphae (B) were treated with 50 μg/ml LsGRP1^{C} for 2 h and 16 h, respectively. Then membrane permeability, chromatin condensation and ROS accumulation of treated spores and hyphae were assayed by staining with SYTOX Green, DAP1 and H₂DCFDA, respectively. Sterile deionized water was used instead of LsGRP1^{C} as a control. Bar=20 μm (A) or 50 μm (B).

FIG. 5 shows microscopic analysis of immunofluorescence staining for :LsGRP1^{C} in the hyphae of plant fungal pathogens. The fungal hyphae were treated with 50 μg/ml LsGRP1^{C} for 16 h before the oberservaion. Sterile deionized water was used instead of LsGRP1^{C} as a control. Bar=25 μm.

### DETAILED DESCRIPTION OF THE PREFERRED EMBODIMENT

In the first aspect the present invention relates to a method of controlling or combating microbial organisms, comprising applying an antimicrobial peptide to the microbial organism, wherein said antimicrobial peptide exhibits antimicrobial activity, such as antifungal activity and antibacterial activity and is selected from the group consisting of LsGRP1^{N} (SEQ ID NO:1), LsGRP1^{G} (SEQ ID NO:2), LsGRP1^{C} (SEQ ID NO:3), and peptide with at least 80% sequence similarity to sequences of LsGRP1^{N}, LsGRP1^{G}, and LsGRPi^{C}.

In a preferred embodiment, the antifungal activity is the activity for inhibiting the growth of fungus, wherein the fungus is selected from the group consisting of Alternaria brassicicola Ac1, Botrytis cinerea B-134, Botrytis elliptica B061, Colletotrichum acutatum HL1, and Colletotrichum gleosporioides MT1 .

In another preferred embodiment, the antibacterial activity is the activity for inhibiting the growth of bacterium, wherein the bacterium is selected from the group consisting of Agrobacterium tumefacients C58C¹, Bacillus subtilis 28-4, Escherichia coli DIT1.5α, Dickey chrysanthemi TA1, Pseudomonas syringae pv. syringae 61, or Xanthomonas campestris XCP3.

The term “antimicrobial polypeptide” is intended to comprise the linear as well as the active folded structures of the polypeptide, and may be used interchangeably with the term “antimicrobial protein”.

The term “antimicrobial activity” means in the context of the present invention that the polypeptide of the invention is active in controlling or combating microbial organisms, including fungal organisms, such as filamentous fungus, and/or bacterial organisms, such as gram-positive and gram-negative bacteria. Suitable assays for assessing whether a polypeptide has antimicrobial activity include but not limit to the ones described in the “Antibacterial assay” and “Antifungal assay” sections.

The present invention also relates to an antimicrobial composition comprising, an antimicrobial peptide of the invention, which may further comprise an additional biocidal agent and pharmaceutically acceptable vehicles, excipients, diluents, and adjuvants.

The invention will now be further illustrated by the following examples. However, it should be noted that the scope of present invention is not limited by the examples provided herein.

### EXAMPLE 1

1. Computational Analysis

The antimicrobial activity of LsGRP1^{N}, LsGRP1^{G} and LsGRP1^{G} deduced from LsGRP1 sequences (NCBI accession number: AAL61539.1) were analyzed using AMP prediction servers AMPA (Torrent et al. 2009), APD2 (Wang and Wang, 2004; Wang et al. 2009), AntiBP2 (Lata et al. 2007), CAMP (Thomas et al. 2010) and ClassAMP (Joseph et al. 2012)

2. Results

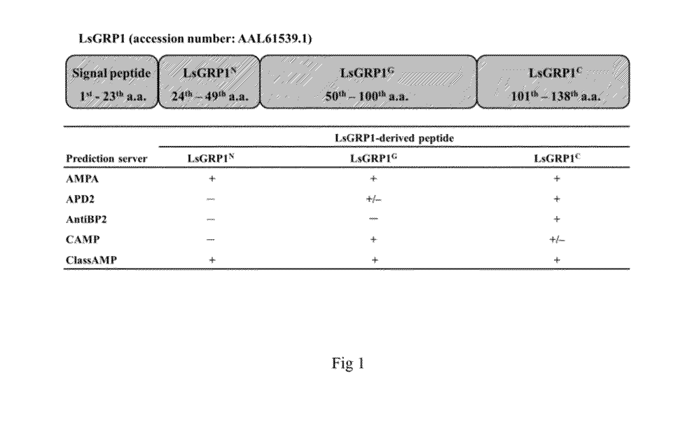

LsGRP1^{N}, LsGRP1^{G} and LsGRP1^{C} were assayed for antimicrobial activity using different AMP, prediction servers (FIG. 1). LsGRP1^{C} possessing antimicrobial activity was suggested by five servers used whereas antimicrobial potentials of LsGRP1^{N} and LsGRP ¹^{G} were only predicted by two and four servers, respectively. Therefore, LsGRP1^{C} might be the main part of LsGRP1 interfering the expression of LsGRP1 in E. coli system.

### EXAMPLE 2

1. Preparation of LsGRP1—Derived Peptides

LsGRP1^{N}, LsGRP1^{G} and LsGRP 1^{C} were chemically synthesized by Genscript USA Inc. with purities greater than 90% after purified by high performance liquid chromatography using a solvent system composed with the mixture of acetonitrile, trifluoroacetic acid and water. The identity of synthetic peptides was confirmed by electrospray ionization mass spectrometry. Synthetic peptides and bovine serum albumin (BSA, Sigma-Aldrich) were all dissolved in sterile deionized water at a concentration of 10 mg/ml and stored at −20□ before use.

2. Microorganisms

The bacterial strains used in this invention included Agrobacterium tumcfaciens C58C¹ (Van Larebeke et al., 1974), Bacillus subtilis 28-4, Escherichia coil DH5α (Invitrogen), Dickey chrysanthemi TA1, Pseudomonas syringae pv. syringae 61 (Huang et al., 1988), and Xanthomonas campestris XCP3. These bacterial strains were cultured on Luria-Bertani (LB) media (1% t ,ryptone, 0.5% yeast extract, 1% NaCl, 1.5% agar) and 523 media (1% sucrose, 0.8% casein hydrolysate, 0.4% yeast extract, 0.2% KH₂PO₄, 0.00358% MgSO₄, 1.5% agar, pH 7.0). The incubation temperature for E. coli DH5α and the other bacterial strains were 37° C. and 28° C., respectively. For antibacterial assay, bacterial strains were incubated in 3 ml LB broth at 180 rpm for 12-16 h and diluted to an experimental concentration using sterile deionized water.

The fungi used in this study included Alternaria brassicicola Ac1, Botlytis cinerea B-134, Botrytis elliptica B061, Colletotrichum acutatum HL1, and Colletotrichum gleosporioides MT1, The B. elliptica B061 was cultured on V-8 medium (20% V-8 vegetable juice [Campbell Soup Company, Camden, N.J., U.S.A.], 0.3% CaCO₃, and 1.5% agar) at 20° C. for 5-8 days whereas the other fungi were cultured on potato dextrose agar (Ditto Laboratories, Detroit, Mich., U.S.A.) at 25° C. for 7-10 days. Spore suspensions of different fungal strains were prepared in sterile deionized water and diluted to an experimental concentration.

3. Growth Inhibition Assay

The antibacterial and antifungal activities of these peptides were determined by measuring the inhibition rate of bacterial growth and fungal spore germination. Bacterial suspensions with an OD₆₀₀ at 0.15 were treated with peptide solution for 90 mm, then serially diluted and plated on LB media. After incubation for 20-24 h, the colony-forming units (CFUs) in each peptide-treated sample were quantified. The inhibition rate (%)=[(CFUs in water treatment CFUs in peptide treatment)/CFUs in water treatment]×100%. On the other hand, fungal spore suspensions of lx10⁵ spores/ml were treated with peptide solutions for 16-20 h, and then the spore germinations were examined under microscope. The germ tube greater than two times of spore length was considered germinated. Inhibition rate (%)[(Number of the spores germinating in water−Number of the spores germinating in peptide solution)/Number of the spores germinating in water]×100%. Sterile deionized water replaced the peptide solution as a control treatment. All assays were performed in triplicate. Based on the data, the concentrations of peptide for 50% growth inhibition (IC₅₀) of each microbe were determined.

4. Results

(1) Antibacterial Activity of LsGRP1-Derived Peptides

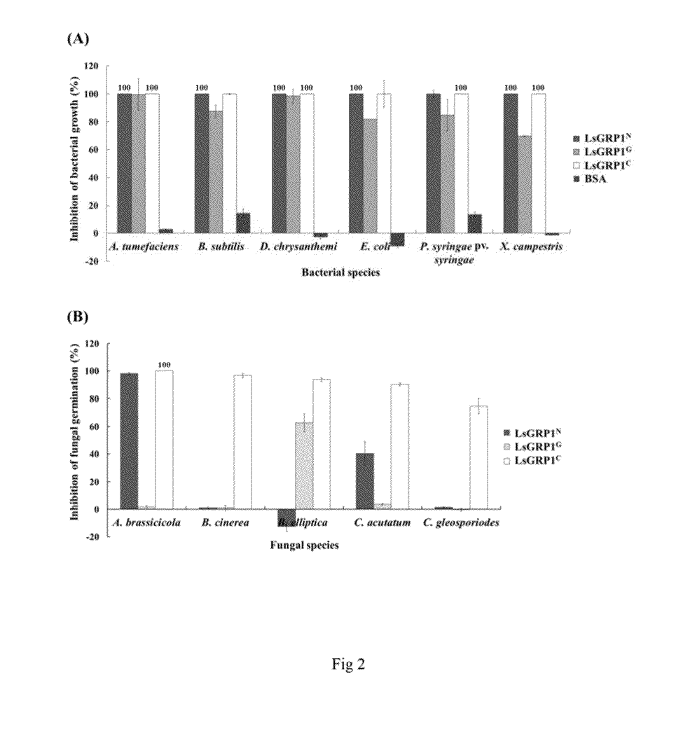

In antibacterial assay, the growths of six bacterial species was significantly inhibited in the presence of 2500 μg/ml LsGRP1-derived peptides but not inhibited by BSA solution (FIG. 2 (A)); thus, these synthetic peptides were considered to have antibacterial activities. Both LsGRP1^{N} and LsGRP1^{C} caused more than 99.5% growth inhibition on all assayed bacterial species whereas LsGRP1^{G} had a lower inhibitory activity. Although LsGRP1^{G} caused over 98.5% inhibition on the growth of A. tumefaciens C58C¹ and D. chrysanthend TA1, the inhibitory effects of LsGRP1^{G} were lower on B. subtilis 28-4 (87.6%), E. coli DH5α (81.8%), P. syringae pv. syringae 61 (84.8%) and X. campestris XCP3 (69.6%). Thus, LsGRP1^{N} and LsGRP1^{G} exhibited higher antibacterial activities and broader spectrum as compared with LsGRP1^{G}.

(2) Antifungal Activity of LsGRP1-Derived Peptides

The antifungal activities of the LsGRP1-derived peptides were investigated by measuring the inhibition rate of spore germination, and LsGRP1^{G} exhibited the highest antifungal activity and broadest spectrum (FIG. 2(B)). LsGRP1^{G} inhibited spore germination by greater than 90% in four fungal strains, A. brassicicola Ac1, B. cinerea B-134, B. elliptica B061 and C. acutatum HL1, while the inhibition rate of spore germination in C. gleosporioides MT1 was 74.7%. On the other hand, ^{LsGRP}1^{N} inhibited spore germinations on A. brassicicola Ac1 and C. acutatum HL1 by 98.0% and 40.3%, respectively; however, the spore germination of B. cinerea B-134 and C. gleosporioides MT1 were not affected. Worthy of notice, LsGRP1^{N} slightly enhanced spore germination of B. elliptica B061 (−12.4% inhibition rate). In contrast to LsGRPI^{N} and LsGRP1^{C}, LsGRP1^{G} did not inhibit spore germination with the exception of B. elliptica B061 (62.7% inhibition rate). Hence, LsCiRP1^{C} is more potent to be an antimicrobial peptide as compared with LsGRP1^{N} and LsGRP1^{G}.

### EXAMPLE 3

LsGRP1^{C} Exhibited Effective Inhibitory Activity on Different Kinds of Bacterial and Fungal Species

To further demonstrate the antimicrobial activity of LsGRP1^{C}, the IC₅₀ values of LsGRP1^{C} on different bacterial and fungal species were determined (Table 1). The IC₅₀ values of LsGRP1^{C} on assayed microbes were all below 86.13 ug/ml, in an effective range of antimicrobial peptide. The IC₅₀ values of LsCRP1^{C} on all assayed bacterial species were lower than 32.19 μg/ml except on A. tumefaciens C58C¹ (IC₅₀=71.79 μg/ml), and E. coli DH5α was most sensitive to LsGRP1^{C} (IC₅₀=9.67 μg/ml). On the other hand, the IC₅₀ values of the assayed fungal species were all below 58.26 μg/ml except that the causal pathogen of lily leaf blight, B. elliptica, exhibited higher tolerance to LsGRP1^{C} (IC₅₀=86.13). According to the IC₅₀ values of LsGRP1^{C} on different bacterial and fungal species, the antimicrobial potency of LsGRP1^{C} was verified.

TABLE 1
IC₅₀ of LsGRP1^{C} on bacterial and fungal species

| Microorganisms | IC₅₀ (μg/ml) |
|---|---|
| Bacterial species^{a} | |
| A. tumefaciens C58C¹ | 71.79 |
| B. subtilis 28-4 | 23.32 |
| E. coli DH5α | 9.67 |
| P. syringae pv. syringae 61 | 20.63 |
| X. campestris XCP3 | 32.19 |
| Fungal species^{b} | |
| A. brassicicola Ac1 | 54.80 |
| B. elliptica B061 | 86.13 |
| B. cinerea B-134 | 58.26 |
| C. acutatum HL1 | 17.39 |

^{a}Inhibition of bacterial growth (OD₆₀₀ = 0.15).
^{b}Inhibition of fungal spore germination at a concentration of 5 × 10⁴ spores/ml.

### EXAMPLE 4

LsGRP1^{C} Altered Bacterial Morphology and Membrane Permeability

1. Scanning Electron Microscopy

Cover slides pre-coated with 0.1% poly-L-lysine were inoculated with 20 μl bacterial suspension of 10⁸ cells/ml and kept moist at 28° C. for 12 h. The bacterial colonies attached to the cover slides were treated with 20 μl peptide solution at a concentration of 2.5, 0.25 or 0.025 mg/ml for 2 h. The cells were fixed using 1% glutaraldehyde and washed three times with 150 mM phosphate buffer (pH 7.2) , each for 15 min. Next, the cells on slides were coated with 1% OSO4 for 1 h, immersed in 2% uranyl acetate for 30 min, and washed three times with 150 mM phosₚhate buffer (pH 7.2) , each for 15 min. The samples were dehydrated serially using 30%, 50% 70%, 85%, 90%, 95%, 100% and 100% ethanol, each for 30 min, then soaked twice in acetone, each for 30 min, dried in CO₂ by a critical point dryer HCP-2 (Hitachi) and coated with gold particles in an ion sputter E101 (Hitachi). The prepared samples were then examined by scanning electron microscope (Inspect 5, FEI Company).

2. SYTOX Green Staining

Bacterial suspension of 10⁸ cells/nil) were treated with peptide solution at different concentrations in the presence of 1 μM SYTOX Green (Invitrogen) , and incubated at 28° C., 180 rpm for 2 h before observation under Leica DMR fluorescence microscope equipped with a Chroma Endow GFP filter set (BP 450-490 nm, DM 495 nm, BP 500-550 nm). Fungal spore and hyphae were treated with 50 μg/ml peptide solution for 2 h and 16 h, respectively, Then the fungal cells were stained with 1 μg/ml SYTOX Green in the dark for 10 mM before observation under Leica DMIL florescent microscope equipped with a Chroma 41012 filter set (BP 460-500 nm, DM 505 nm, LP 510 nm). Sterile deionized water was used instead of peptide solution as a control.

3. Results

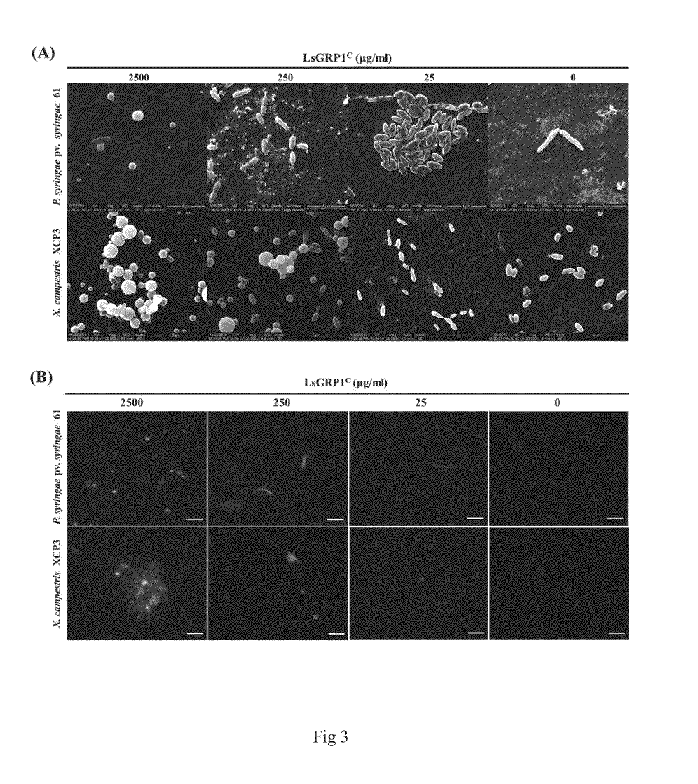

The effects of LsGRP1^{C} on the morphology of two bacterial strains, P. syringae pv. syringae 61 and X. campestris XCP3, were examined by scanning electron microscopy. Transformation of a significant number of bacterial cells from rod-shaped to spherical-shaped was observed in both P. syringae pv. syringae 61 and X. campestris XCP3 upon treatment with 2500 μg/ml LsGRP1^{C} (FIG. 3(A)). When the concentration of LsGRP1^{C} treatment was decreased, the cells of P. syringae pv. syringae 61 and the X campestris XCP3 exhibited a shorten and swollen morphology as compared with the untreated ones, indicating a dose-dependent effect of LsGRP1^{C}.

The morphological change in bacterial cells caused by LsGRP1^{C} implied the cell membrane of bacteria was damaged by LsGRP1^{C}, and SYTOX Green was subsequently used to demonstrate the effect of LsGRP1^{C} on bacterial membrane. SYTOX Green is impermeable to normal cells but penetrates to damaged cell membranes and causes nuclei florescent. Under fluorescent microscope, fluorescent nuclei were observed in P. syringae pv. syringae 61 and X. campestris XCP3 cells post treatments with LsGRP1^{C} but not in the water control (FIG. 3(B)), indicating that LsGRP1^{C} altered membrane integrity and changed the permeability of bacterial membranes. Moreover, the proportion of SYTOX Green-labeled bacteria positively correlated to the concentrations of LsGRP1^{C}, which was consistent With the morphological changes affected by the treatment with LsGRP1^{C}.

### EXAMPLE 5

LsGRP1^{C} Destroyed Membrane Integrity and Induced Programmed Cell Death-Like Phenomenon in Fungi

1. DAN Staining

Fungal spore and hyphae were treated with 50 μg/ml peptide solution for 2 h and 16 h, respectively. Then the fungal cells were stained with 4′,6′-diamidino-2-phenylindole (DAPI) at a finial concentration of 1 pg/ml in the dark for 10 min. before observation under Leica DMIL florescent microscope equipped with a Leica A filter set (BP 340-380 nm, DM 400 nm, LP 425 nm). Sterile deionized water was used instead of the peptide solution as a control.

2. H₂DCFDA Staining

Fungal spore and hyphae were treated with 50 μg/ml peptide solution for 2 h and 16 h, respectively. Then the fungal cells were stained with 10 μM H₂DCFDA in the dark for 60 min before observation under Leica DMIL florescent microscope equipped with a Chroma 41012 filter set. Sterile deionized water was used instead of peptide solution as a control.

3. Results:

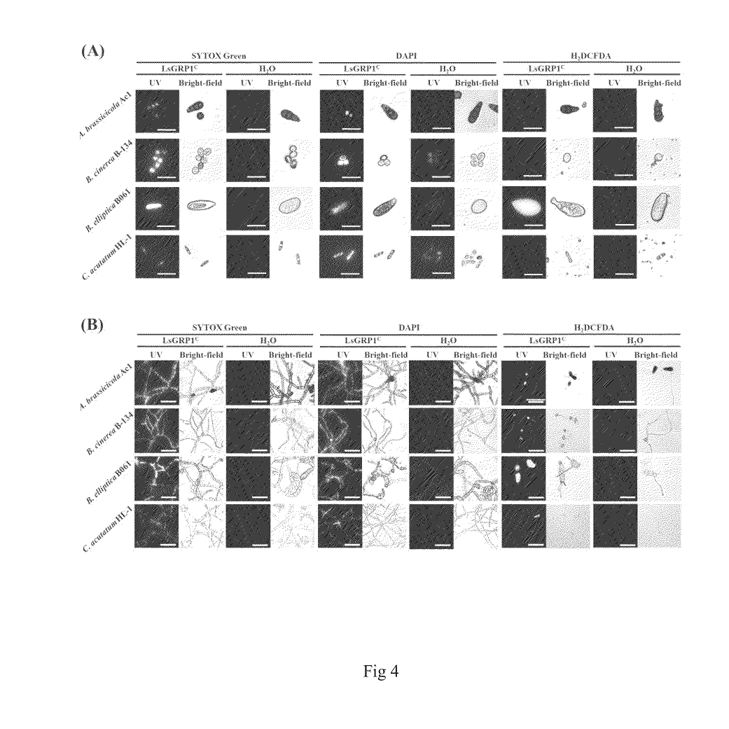

The effects of LsGRP1^{C} on spores and hyphae of A. brassicicola Ac1, B. cinerea B-134, B. elliptica B061 and C. acutatum HL1 were demonstrated (FIG. 4). As observed under light microscope, the spores and hyphae of LsGRP1^{C}-treated fungal species, especially B. elliptica, the causal pathogen of lily leaf blight, exhibited abnormal blebbing and shrinkage, and their cytoplasm had a brown, necrotic and granulated appearance. In contrast, fungal spores and hyphae of the control had a smooth, full surface and transparent, homogeneous cytoplasm.

The damages caused by LsGRP1^{C} to the plasma membrane of spores and hyphae were visualized by SYTOX Green-labeled florescent signal which was not detected in the control, demonstrating that LsGRP1^{C} affected the membrane integrity of all tested fungal species. /Meanwhile, the nuclei of spores and hyphae stained by DAPI showed that LsGRP1^{C} leaded to fungal nuclear chromatin condensation, a characteristic change of programmed cell death, which did not occurred in the control. In addition, the accumulation of reactive oxygen species (ROS) in the germinating spores pretreated with LsGRP1^{C} was visualized by H₂DCFDA staining but not in the control (FIG. 4(B)), providing evidence that LsGRP1^{C} probably induced programmed cell death-like phenomenon in fungi (Sharon et al. 2009). Interestingly, the ROS accumulation triggered by LsGRP1^{C} was absent in the non-germinating spores of A. brassicicola, B. cinerea, and C. acutatum but present in B. elliptica (FIG. 4(A)), suggesting a faster response of B. elliptica to LsGRP1^{C}. To sum up these results, LsGRP1^{C} is able to destroy the membrane integrity and induce a programmed cell death-like phenomenon in different fungal species.

### EXAMPLE 6

Localization of the Acting Target of LsGRP1^{C}

1. Immunofluorescence Microscopy

At first, the fungal hyphae treated with 50 μg/ml LsGRP1C for 16 h were fixed with 4% formaldehyde in phosphate-buffered saline (PBS, 137 mM NaCl, 2.7 mM KCl, 10 mIVI. Na₂HPO₄, 2 mM KH₂PO₄, pH 7.4) for 1 h, treated with 25 mM dithiothreitol in PBS for 20 min, and then digested with 20 mg/ml chitinase in PBS containing 5 μl/ml β-mercaptoethanol for 30 min. Then, the hyphae were immunostained using LsGRP1^{C} antibody and fluorescein isothiocyanate (FITC)-labeled anti-rabbit IgG antibody (KPL) subsequently. The hyphae were observed under Leica DMIL florescent microscope equipped with a CHROMA 41012 filter set (BP 460-500 nm, DM 505 nm, LP 510 nm). LsGRP1^{C} antibody was prepared from the antiserum of the rabbit immunized with chemically synthetized partial C-terminal sequences of the deduced LsGRP1 (accession number: AAL61539.1) after purified through LsGRP1^{C} affinity column. Sterile deionized water was used instead of peptide solution as a control.

2. Results:

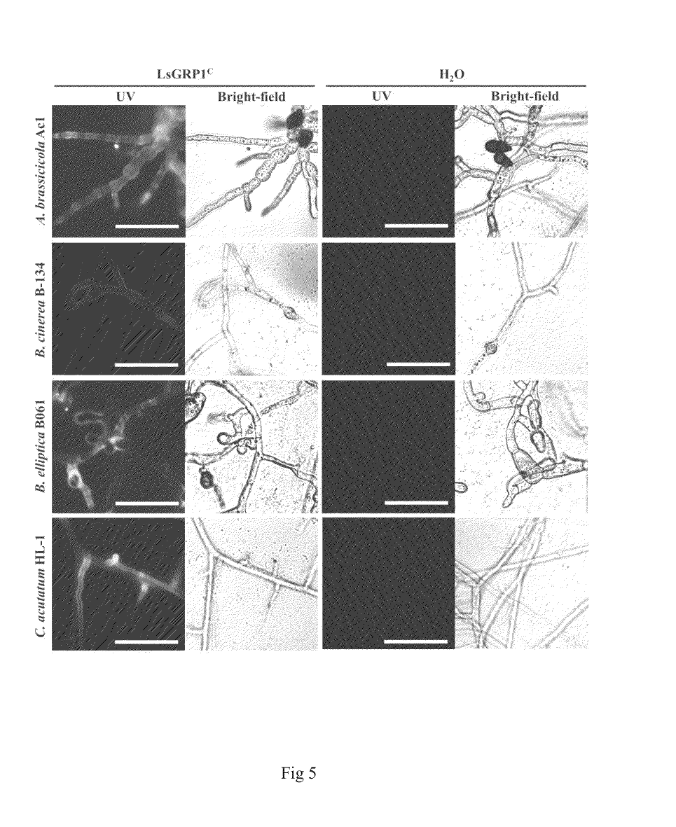

To investigate the acting target of LsGRP1^{C}, the fungal hyphae treated with LsGRP1^{C} were hybridized with LsGRP1^{C} antibody, and stained with FITC-conjugated anti-rabbit IgG antibody. The fluorescent signals of FITC labeled all LsGRP1^{C}-treated fungal hyphae whereas no signals were observed in the water control (FIG. 5). Since fluorescent signals was mostly localized to the outer layer of hyphae and few of them were found inside the hyphal cells, most LsGRP1^{C} perhaps bound to fungal cell wall and/or plasma membrane and altered the integrity of fungal membrane; thereby, a few inflow of LsGRP1^{C} into hyphal cells would occur subsequently.

### CONCLUSION

All the prediction servers used in this invention suggested that an antimicrobial activity mainly conferred by LsGRP1^{C}. However, in practical assays, LsGRP1^{N}, LsGRP1^{G} and LsGRP1^{C} of 2500 μg/ml exhibited high inhibitory activities on both Gram (+) and Gram (−) bacteria as compared with the BSA control, suggesting that not only the cysteine-rich C-terminal region of LsGRP1 protein but also other regions were toxic to bacteria. Furthermore, the low IC₅₀ value of LsGRP1^{C} on E. coli DH5α (9.67 μg/ml) indicated that E. coli was highly Sensitive to the expressed LsGRP1 bearing LₛGRP1^{C} region, and the unsuccessful production of LsGRP1 in E. coli was due to the antimicrobial activity conferred by the C-terminal cysteine region and also other parts of LsGRP1. Since the antimicrobial potency of LsGRP1^{C} on different bacterial and fungal species was demonstrated, herein, a defense-related protein unable overexpressed in a microbial system might be a resource for the evaluation of novel AMPs.

Although the three LsGRP1-derived peptides effectively inhibited all of the bacterial species investigated (81-100% inhibition), only LsGRP1^{C} inhibited all the fungal strains investigated to a high degree, which was consistent with the predicted antimicrobial activity for this peptide by AMP prediction servers. The antimicrobial activity and spectrum of LsGRP1^{C} were further demonstrated by the low IC₅₀ values on various kinds of bacterial and fungal species. The combined traits of effective inhibitory activity and broad antimicrobial spectrum of LsGRP1^{C} suggested that this peptide could act on certain common targets or has diverse effects on microbial physiology. In SYTOX Green staining assay, LsGRP1^{C} was shown to disrupt the membrane integrity of both bacterial and fungal cells, which is a common property of cationic cysteine-rich AMPs (Brogden, 2005; R.ahnamaeian, 2011). Moreover, LsGRP1^{C} was localized to the cell surface of fungal hyphae providing evidence of the cell wall and/or plasma membrane location of the acting target of LsGRP1^{C}. In addition to membrane permeabilization, LsGRP1^{C} caused nuclear chromatin condensation and ROS accumulation in four treated fungal species, indicating that LsGRP1^{C} would induce fungal program cell death. Worthy to notice, the LsGRP1^{C} triggered-ROS accumulation of non-germinating spores only appeared in B. elliptica, a lily pathogen, but not in other three fungal species, suggesting that B. elliptica exhibited a higher sensitivity in response to LsGRP1^{C}. Other than a mediator of plant programmed cell death, the ROS generated by plant fungal pathogens may play a role in fungal signaling, virulence and development (Heller and Tudzynski, 2011). The earlier ROS accumulation in B. elliptica triggered by LsGRP1^{C} was probably due to the host-specific recognition. Therefore, LsGRP1^{C} may not only directly alter membrane integrity in both bacterial and fungal microorganisms, but also induce programmed cell death-like phenomenon at least in some fungi. The antimicrobial activity of LsGRP1^{C} might be a result of multiple effects on microorganisms.

The morphological transformation and membrane permeabilization of bacteria triggered by LsGRP1^{C} are similar to the changes occurring in irreversible terminal differentiation of nitrogen-fixing bacteria into bacteroids, which is governed by AMP-like nodule-specific cysteine-rich peptides (NCRs) secreted by the inverted repeat-lacking Glade (IRLC) of legumes during symbiosis (Van de Velde et al. 2010). Since BacA protein of nitrogen-fixing bacteria may confer resistance against the bactericidal effects of host NCRs probably by reducing the extent of NCR-induced membrane permeabilization and killing of bacterial cells; thus, the nitrogen-fixing bacteria can maintain alive in the presence of NCRs (Haag et al. 2011). However, the morphological transformation, membrane permeabilization and cell death of bacteria appeared within 60 min post treatment of LsGRP1^{C}, indicating that LsGRP1^{C}-triggered destruction of bacteria rapidly happened. Besides, because the major determinant of bacterial morphology is the cell wall peptidoglycan sacculus synthesized by the complexes located in bacterial membrane (Typas et al. 2011), the abnormal bacterial morphology induced by LsGRP1^{C} might arise from the damage to peptidoglycan sacculus or the interference in sacculus biosynthetic pathway following membrane alteration.

LsGRP1 is a defense-related gene with an increased expression in lily exhibiting salicylic acid-induced systemic resistance against B. elliptica (Chen et al. 2003; Lu and Chen, 2005), and could enhanced disease resistance in vivo as overexpressed in Arabidopsis thaliana and Nicotiana henthamiana. Recently, the host-induced fungal programmed cell death triggered by phytoalexin camalexin was shown to protect A. thaliana from B. cinerea infection (Shlezinger et al. 2011a,b). In addition, a number of plant AMPs and antimicrobial compounds have been suggested as inducers of programmed cell death in fungi (De Brucker et al. 2011; Rahnamaeian, 2011). In this invention, in vitro inhibitory mechanism of LsGRP1^{C} on B. elliptica suggested that LsGRP1 might confers plant disease resistance via inducing fungal membrane permeabilization and programmed cell death. In contrast, the slight enhancement of spore germination in B. elliptica caused by LsGRP1^{N} treatment might be owing to that B. elliptica recognizes the corresponding region of LsGRP1 as a host signal resulted from the long-term coevolution of B. elliptica and lily. However, the underlying mechanisms of the effects of different regions of LsGRP1 on B. elliptica require further investigation.

In this invention, a novel AMP derived from a defense-related protein of lily was demonstrated and the results revealed that plant defense-related proteins incapable of overexpression in E. coli system would become a natural resource of novel AMPs for practical use.

1. A method of controlling or combating microbial organisms, comprising applying a chemically synthesized antimicrobial peptide to a bacterium or a fungus, wherein the antimicrobial peptide is selected from the group consisting of LsGRP1^{N} (SEQ ID NO:1), LsGRP1^{G} (SEQ ID NO:2), LsGRP1^{C} (SEQ ID NO:3), wherein the bacterium is selected from the group consisting of Agrobacterium tumefaciens, Bacillus subtilis, Escherichia coli, Dickey chrysanthemi, Pseudomonas syringae pv. syringae, and Xanthomonas campestris, wherein the fungus is selected from the group consisting of Alternaria brassicicola, Botrytis cinerea Botrytis elliptica, Colletotrichum acutatum, and Colletotrichum gleosporioides, wherein LsGRP1^{N} (SEQ ID NO:1) inhibits spore germinations on Alternaria brassicicola and Colletotrichum acutatum, wherein LsGRP1^{G} (SEQ ID NO:2) inhibits spore germinations on Botrytis elliptica, wherein LsGRP1^{C} (SEQ ID NO:3) inhibits spore germinations on Alternaria brassicicola, Botrytis cinerea, Botrytis elliptica, Colletotrichum acutatum, and Colletotrichum gleosporioides.

2. The method of claim 1, wherein LsGRP1^{N} (SEQ ID NO:1) and LsGRP1^{C} (SEQ ID NO:3) causes 99.5% growth inhibition on Agrobacterium tumefaciens, Bacillus subtilis, Escherichia coli, Dickey chrysanthemi Pseudomonas syringae v. syringae, and Xanthomonas campestris.

3. The method of claim 1, wherein LsGRP1^{G} (SEQ ID NO:2) causes 98.5% growth inhibition on Agrobacterium tumefaciens and Dickey chrysanthemi, and 87.6% growth inhibition on Bacillus subtilis, 81.8% growth inhibition on Escherichia coli, 84.8% growth inhibition on Pseudomonas syringae pv. syringae and 69.6% growth inhibition on Xanthomonas campestris.

4. The method of claim 1, wherein LsGRP1^{N} (SEQ ID NO:1) inhibits spore germinations on Alternaria brassicicola and Colletotrichum acutatum by 98.0% and 40.3%, respectively.

5. The method of claim 1, wherein LsGRP1^{G} (SEQ ID NO:2) inhibits spore germinations on Botrytis elliptica by 62.7%.

6. An antimicrobial composition for inhibiting a bacterium or a fungus, said antimicrobial composition comprising:
a chemically synthesized antimicrobial peptide, wherein the antimicrobial peptide is selected from the group consisting of LsGRP1^{N} (SEQ ID NO:1), LsGRP1^{G} (SEQ ID NO:2), LsGRP1^{G} (SEQ ID NO:3);
an additional biocidal agent; and
pharmaceutically acceptable vehicles, excipients, diluents, and adjuvants,
wherein the bacterium is selected from the oup consisting of Agrobacterium tumefaciens, Bacillus subtilis, Escherichia coli, Dickey chrysanthemi, Pseudomonas syringae pv. syringae, and Xanthomonas campestris, wherein the fungus is selected from the group consisting of Alternaria brassicicola, Botrytis cinerea, Botrytis elliptica, Colletotrichum acutatum, and Colletotrichum gleosporioides, wherein LsGRP1^{N} (SEQ ID NO:1) inhibits spore germinations on Alternaria brassicicola and Colletotrichum acutatum, wherein LsGRP1^{G} (SEQ ID NO:2) inhibits spore germinations on Botrytis elliptica, wherein LsGRP1^{C} (SEQ ID NO:3) inhibits spore germinations on Alternaria brassicicola, Botrytis cinerea, Botrytis elliptica, Colletotrichum acutatum, and Colletotrichum gleosporioides.

7. The antimicrobial composition of claim 6, wherein LsGRP1^{N} (SEQ ID NO:1) and LsGRP1^{C} (SEQ ID NO:3) causes 99.5% growth inhibition on Agrobacterium tumefaciens, Bacillus subtilis, Escherichia coli, Dickey chrysanthemi, Pseudomonas syringae pv. syringae, and Xanthomonas campestris.

8. The antimicrobial composition of claim 6, wherein LsGRP1^{G} (SEQ ID NO:2) causes 98.5% growth inhibition on Agrobacterium tumefaciens and Dickey chrysanthemi, and 87.6% growth inhibition on Bacillus subtilis, 81.8% growth inhibition on Escherichia coli, 84.8% growth inhibition on Pseudomonas syringae v. syringae and 69.6% growth inhibition on Xanthomonas campestris.

9. The antimicrobial composition of claim 6, wherein LsGRP1^{N} (SEQ ID NO:1) inhibits spore germinations on Alternaria brassicicola and Colletotrichum acutatum by 98.0% and 40.3%, respectively.

10. The antimicrobial composition of claim 6, wherein LsGRP1^{G} (SEQ ID NO:2) inhibits spore germinations on Botrytis elliptica by 62.7%.

11. The method of claim 1, wherein LsGRP1^{C} (SEQ ID NO:3) inhibits 90% of spore germinations on Alternaria brassicicola, Botrytis cinerea, Botrytis elliptica and Colletotrichum acutatum, and 74.4% of spore germinations on Colletotrichum gleosporioides.

12. The antimicrobial composition of claim 7, wherein LsGRP1^{C} (SEQ ID NO:3) inhibits 90% of spore germinations on Alternaria brassicicola, Botrytis cinerea, Botrytis elliptica and Colletotrichum acutatum, and 74.4% of spore germinations on Colletotrichum gleosporioides.

13. A bandage comprising the antimicrobial composition of claim 6.

14. An anti-dandruff hair product comprising the antimicrobial composition of claim 6.

15. A medical wipe comprising the antimicrobial composition of claim 6.
